(19) United States
(12) Patent Application Publication
(10) Pub. No.: US 2013/0068912 A1
(43) Pub. Date: Mar. 21, 2013

(54) TRIPOD BASE WITH ENHANCED SUPPORT FORCE

(71) Applicant: Bean Yang, New Taipei City (TW)

(72) Inventor: Bean Yang, New Taipei City (TW)

(21) Appl. No.: 13/237,090

(22) Filed: Sep. 20, 2011

(51) Int. Cl. F16M 11/22

(52) U.S. Cl. 248/440; 248/440.1

(57) ABSTRACT

A tripod base with enhanced support force has a flat base and three supporting rods. The flat base has a side, a bottom surface, a tube mounting hole and three slots arranged as a triangle at the bottom surface. Each slot has an inner closed end and an outer open end that is formed through the side. Each supporting rod has a first end pivotally mounted in one corresponding slot and has an inner segment held in the corresponding slot. Because the three slots are arranged as a triangle, contact area is increased between the supporting rod and the flat base to disperse the loading to the three supporting rods, thereby enhancing the supporting force. Further, the center of gravity of the flat base is lowered because of the flat shape to prevent the tripod base from toppling over.

### BACKGROUND OF THE INVENTION

1. Field of the Invention

The present invention relates to a tripod base, and more particular to a tripod base with enhanced support force.

2. Description of Related Art

A conventional tripod base as shown in FIG. 9 comprises a base 60 and three supporting rods 70. A tube 100 of a stand, such as a music stand, can be mounted in the tripod base.

The base 60 has an upright central tube 61 and three ribs 62. The central tube 61 has an upward nozzle 63. The three ribs 62 equidistantly surround the central tube 61. A lower side of the rib 62 forms a supporting rod fixing hole 64 inwardly. The rib 62 further forms a screw hole communicating with the supporting rod fixing hole 64.

Each of the three supporting rods 70 has a first end and a second end. The first end of each supporting rod 70 is plugged in the supporting rod fixing hole 64. The first end of each supporting rod 70 also has a screw hole corresponding to the screw hole of the rib 62. A screw 71 penetrates through the screw holes of the rib 62 and the supporting rod 70. A screw nut 72 coordinates to fasten the screw 71 to fasten the supporting rod 70 in the supporting rod fixing hole 64.

The base 60 is supported by multiple supporting rods 70. The tube 100 is fastened in the central tube 61 of the base 60 for standing. But each supporting rod 70 of the conventional tripod base is only secured to the base 60 via one end, i.e. the first end. Thus, the weight of the base 60 and the stand will be concentrated on the first end of the supporting rod 70. Therefore, the firs end of the supporting rod 70 often breaks up because of the heavy loading. Besides, because the center of gravity of the base 60 is too high, the tripod base will be unsteady and fall down easily. Furthermore, because the multiple supporting rods 70 of the tripod base are fastened by the screws 71 in the supporting rod fixing holes 64 of the base 60, the tripod base is not foldable.

To make the tripod base and the tube 100 be securely connected together, a top end of one rib 62 provides a fixed plug-in hole 65 communicating with the central tube 61. The fixed plug-in hole 65 forms inner threads to receive a fixed plug-in element 80. The fixed plug-in element 80 is substantially T-shaped and has a straight rod 81 and a horizontal rod 82. The straight rod 81 forms outer threads and is fastened to the fixed plug-in hole 65 of the base 60.

When the tube 100 is going to be connected to the base 60, the straight rod 81 of the fixed plug-in element 80 is screwed into the fixed plug-in hole 65 to tightly abut against the tube 100. However, the user needs to repeatedly turn the fixed plug-in element 80 to make the straight rod 81 move into the central tube 61 of the base 60 until the tube 100 has been securely mounted in the central tube 61. Therefore, either the disassembling or the assembly of the tube 100 is inconvenient.

### SUMMARY OF THE INVENTION

A main objective of the invention is to provide a tripod base with enhanced support force.

To accomplish the objective, the tripod base has a flat base and three supporting rods.

The flat base comprises a side, a bottom surface, a tube mounting hole formed through the bottom surface, and three slots formed in the bottom surface, each slot having an inner closed end and an outer open end that is formed through the side, wherein the three slots are arranged as a triangle around the tube mounting hole as a center. The supporting rods are pivotally mounted in the three slots. Each of the supporting rods comprises a first end pivotally mounted in the inner closed end of one of the slots, an inner segment near the first end held in one of the slots, and a second end exposed outside of the flat base.

The three slots are arranged as a triangle. The three supporting rods are mounted in the slots via the inner segments to increase contact area. Therefore, the loading over the tripod base can be dispersed to the flat base and the three supporting rods to enhance the support capability. Furthermore, the center of gravity of the flat base is lowered to prevent the tripod base from falling down.

Another objective of the invention is to provide a tripod base being convenient for storage.

The flat base further has at least one through hole communicating with the tube mounting hole and one of the slots. A fastening element is mounted in the through hole.

When the tripod base is in use, one of the supporting rods will push the fastening element. Thus, the fastening element will slightly move toward the tube mounting hole and tightly abut against a tube of a stand, such as a music stand.

When the tripod base is to be stored, each supporting rod is pivoted to disengage from each slot, and the fastening element is not compressed by the supporting rod any more. Thus, the tube of the stand can move freely in the tube mounting hole. Therefore, as long as each supporting rod is pivoted to disengage from each slot and to be in an upright position, the flat base can slide along the tube of the stand for convenient storage.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a tripod base of the invention connected with a tube of a stand;

FIG. 2 is an exploded perspective view of the tripod base of FIG. 1;

FIG. 3 is a bottom view of the tripod base of FIG. 1;

FIG. 4 is an exploded top perspective view of the tripod base in FIG. 2 being assembled;

FIG. 5 is a bottom perspective view of the tripod base of FIG. 3;

FIG. 6 is a cross-section view of the tripod base of FIG. 1 being folded;

FIG. 7 is a perspective view of the tripod base of FIG. 1 being folded;

FIG. 8 is a cross-section view of the tripod base of FIG. 1 in a standing position; and

FIG. 9 is a perspective view of a conventional tripod base.

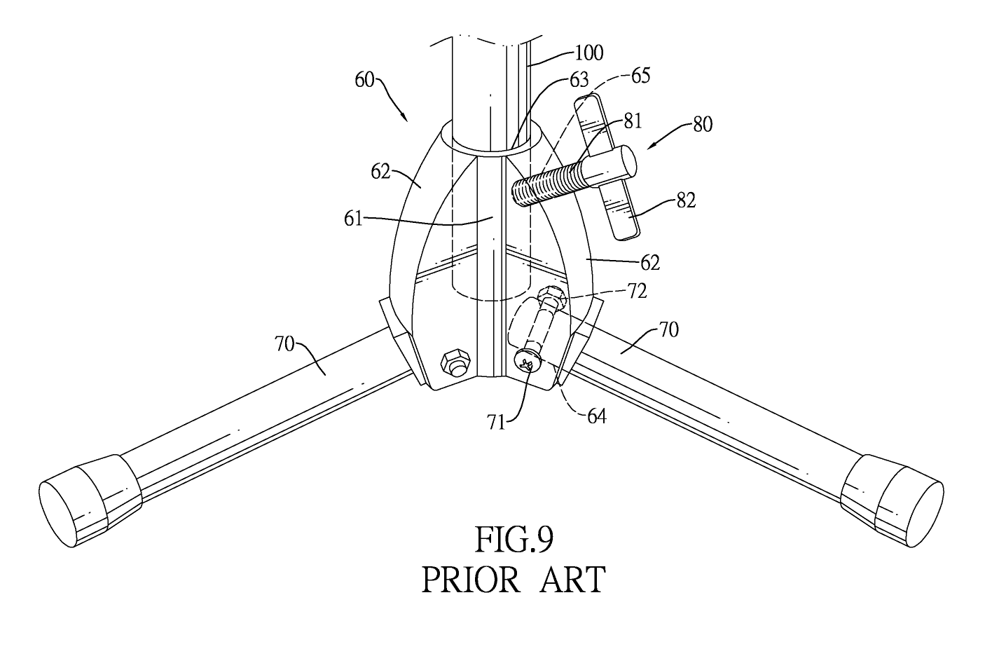

### DETAILED DESCRIPTION OF THE PREFERRED EMBODIMENT

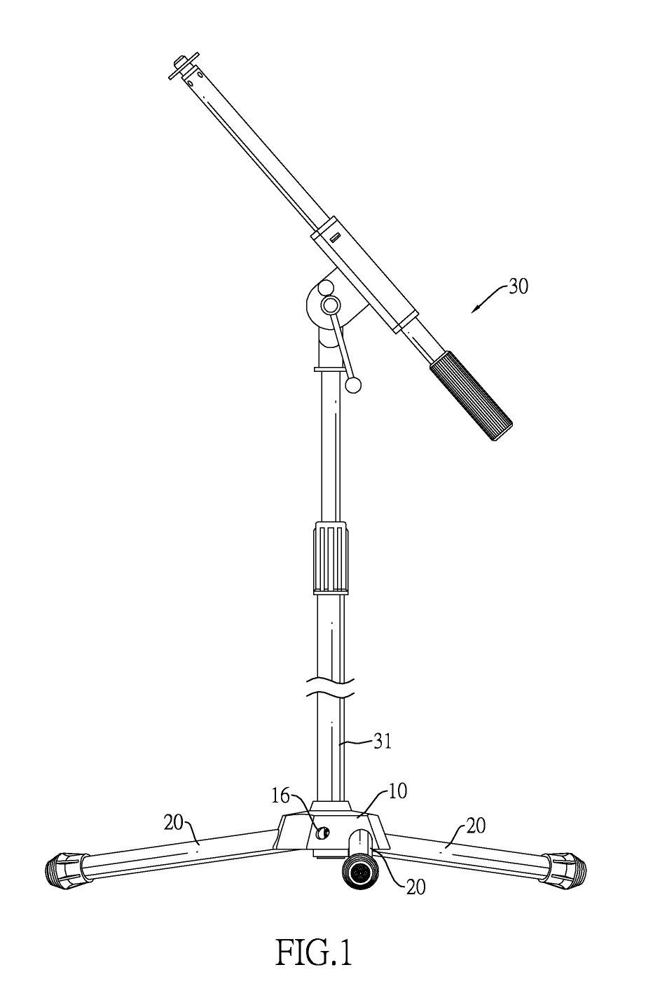

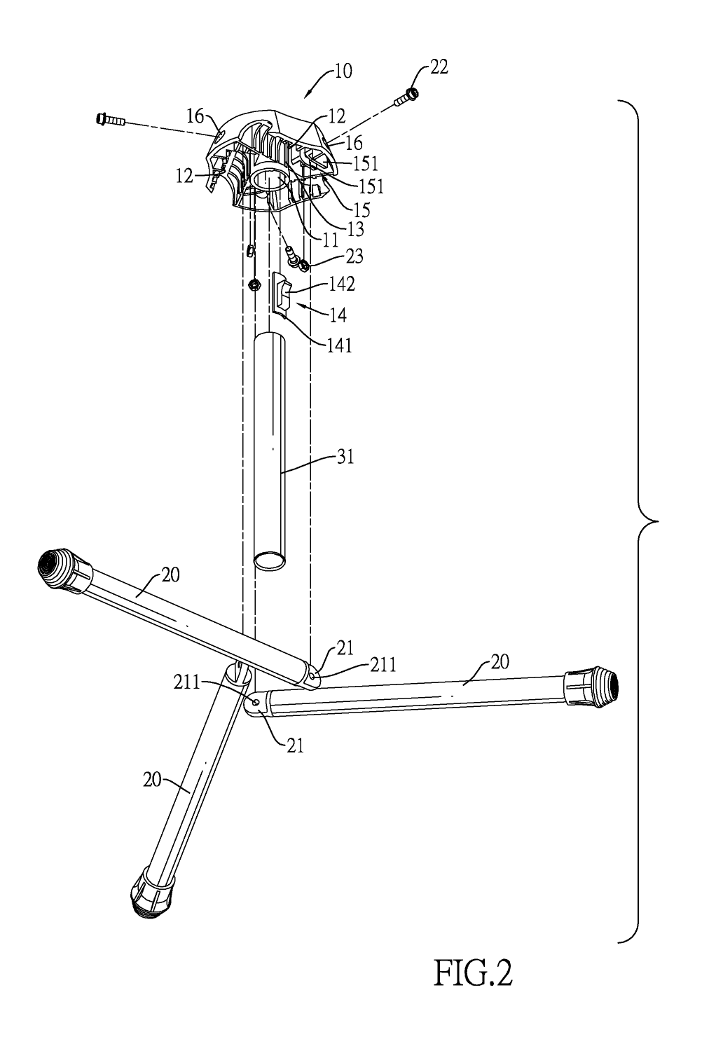

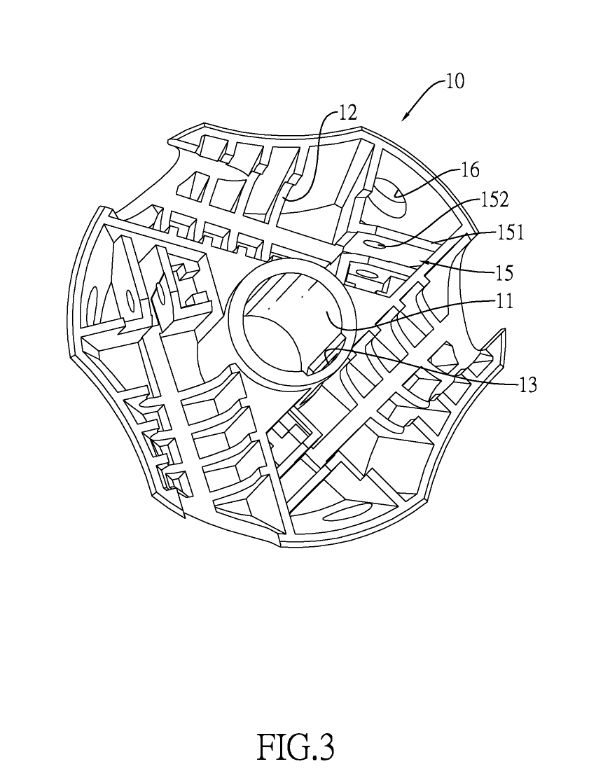

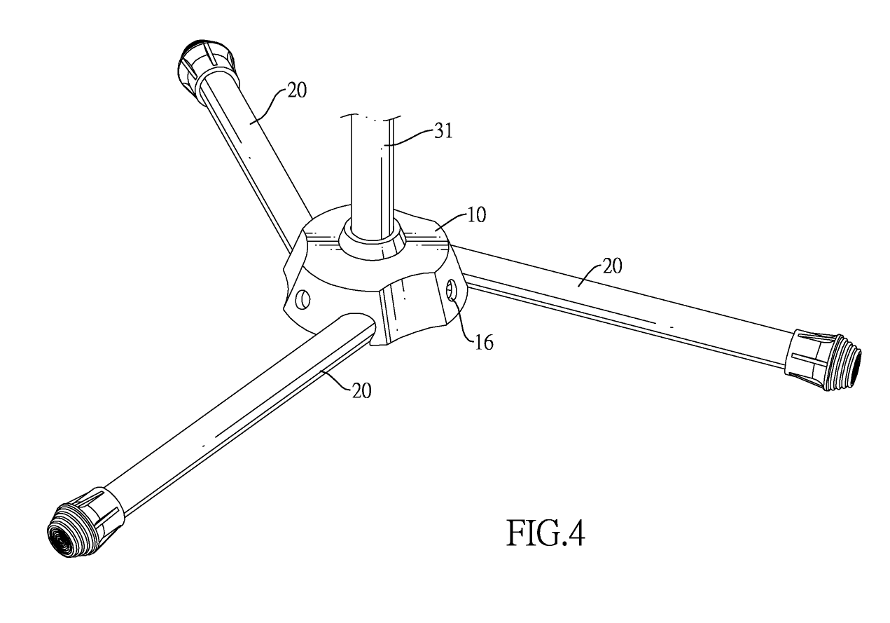

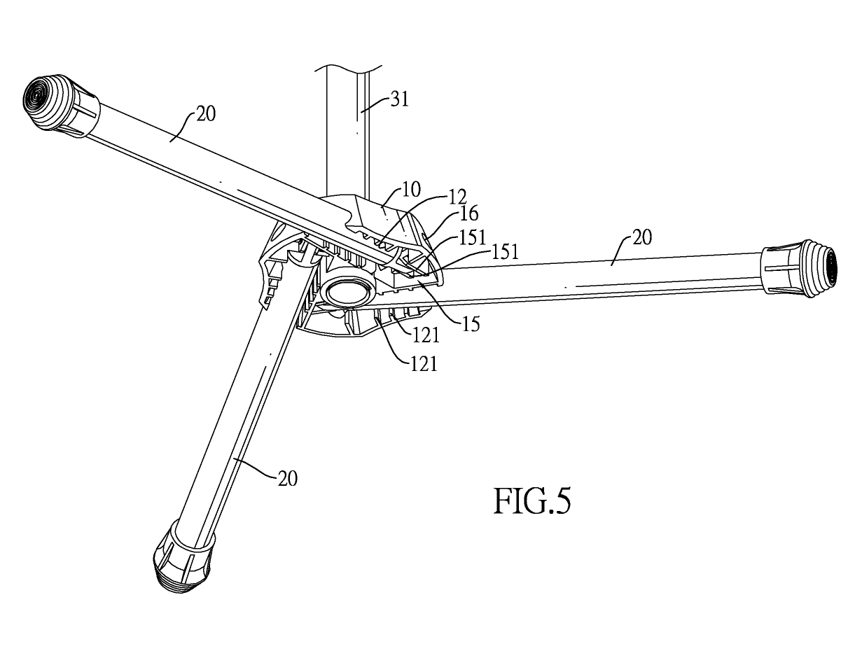

With reference to FIGS. 1 to 5, a tripod base with enhanced support force comprises a flat base 10 and three supporting rods 20.

The flat base 10 has a side, a bottom surface, a tube mounting hole 11 formed through the center and three slots 12 formed on the bottom surface. Each slot 12 comprises an inner closed end and an outer open end formed on the side of the flat base 10. The three slots 12 are arranged as a triangle, and the tube mounting hole 11 is located at a center of the three slots 12. In this embodiment, the tube mounting hole 11 forms through the bottom surface of the flat base 10 and communicates with one of the slots 12 via a through hole 13.

A fastening element 14 is mounted in the through hole 13 and protrudes from the slot 12. The fastening element 14 has a prop-press piece 141 and a bump 142. The prop-press piece 141 faces toward the tube mounting hole 11. The bump 142 is formed on the prop-press piece 141 and held in the tube mounting hole 11, and protrudes toward the slot 12. A pin jointed base 15 is formed in the bottom of the flat base 10 and near the inner closed end of each slot 12. The pin jointed base 15 comprises two plates 151 in parallel. Each of the two vertical plates 151 forms an axial hole 152 respectively.

The three supporting rods 20 are placed horizontally. Each supporting rod 20 comprises an inner segment, a mounting end and a free end. The mounting end of each supporting rod 20 is mounted to the inner closed end of each slot 12. The inner segment of the supporting rod 20 near the mounting end is held in a corresponding slot 12. The free end of the supporting rod 20 is exposed outside of the flat base 10.

In this embodiment, each of the supporting rods 20 has a connecting ear 21 formed at the mounting end. An axial hole 211 is formed on the connecting ear 21. The connecting ear 21 is mounted between the two plates 151 of the pin jointed base 15 to make the axial hole 211 align with the axial holes 152 of the two plates 151. A hinge 22 with external threading penetrates through the axial holes 152 of the two plates 151 and the axial holes 211 of the connecting ear 21. A screw nut 23 can be used to fasten the hinge 22 to make the supporting rod 20 be pivotally connected to the pin-jointed base 15. The supporting rod 20 that corresponds to the fastening element 14 is able to push the bump 142 of the fastening element 14 inward so that the prop-press piece 141 is moved toward the tube mounting hole 11.

The flat base 10 may further have a hole 16 formed through its side. Therefore, each hinge 22 can extend through the hole 16 and further through the two vertical plates 151 and the axial holes 211 of the connecting ears 21 to provide a pivot connection.

In another embodiment, the flat base 10 may have three through holes 13 respectively communicating with the three slots 12, and three fastening elements 14 are mounted in the three through holes 13. The three fastening elements 14 are able to abut the tube 31 at the same time to enhance the supporting effect.

Because the base 10 is relatively flat, the three slots 12 are arranged as a triangle, and the three supporting rods 20 are held in the slots 12 by their inner segments, the loading over the base 10 is dispersed to the triangle configuration for enhancing the supporting capability. Furthermore, the center-of-gravity of the flat base 10 is lowered to prevent the tripod base from toppling over.

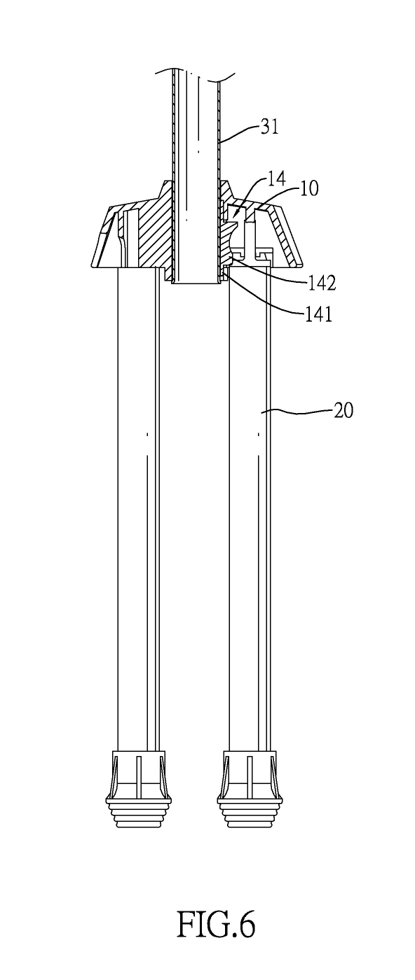

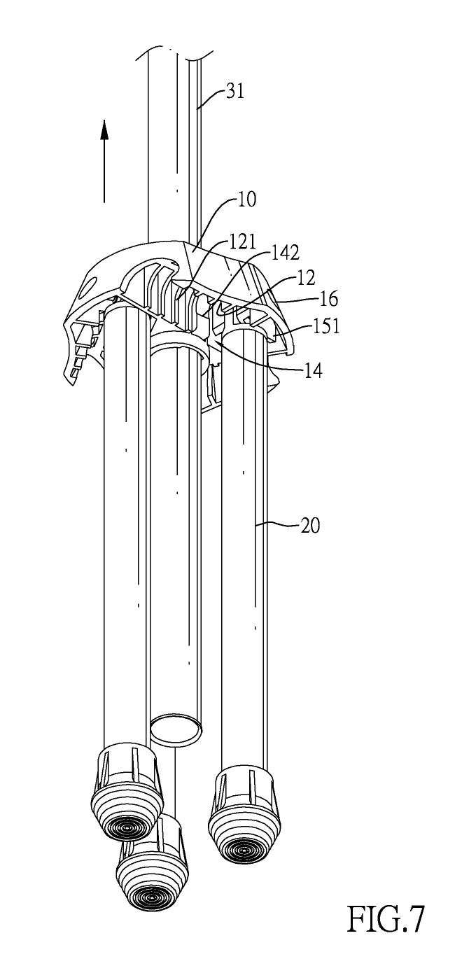

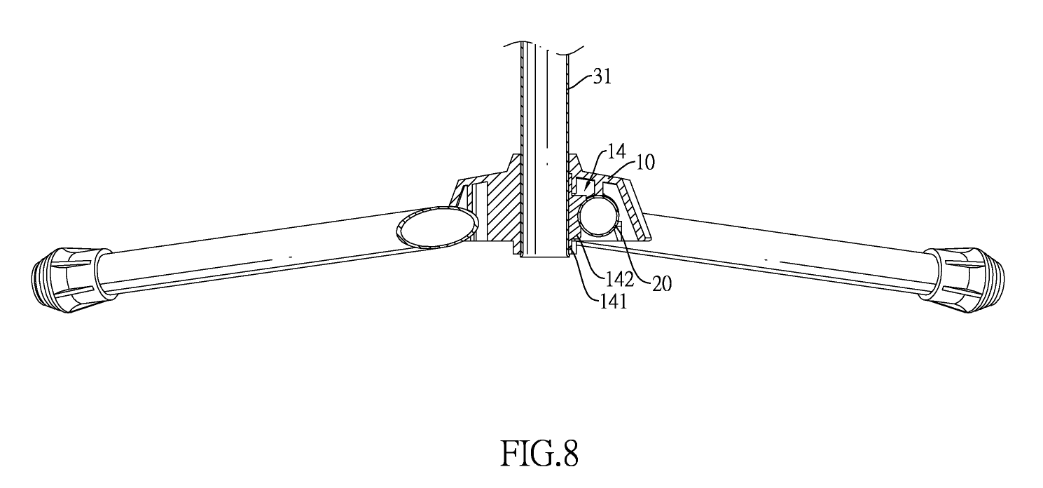

With reference to FIGS. 6 to 8, when the tripod base is in use, the tube 31 of the stand 30 is mounted in the tube mounting hole 11. The fastening element 14 is pushed inward by the supporting rod 20 to tightly abut the tube 31 as shown in FIG. 8. When the tripod base is to be stored, the three supporting rods 20 are pivoted to disengage from the slots 12 in an upright status as shown in FIGS. 6 and 7. Because the supporting rod 20 disengages from the bump 142 to release the fastening element 14, the tube 31 is not pressed by the fastening element 14 any more. If the flat base 10 is moved upward, the free ends of the supporting rod 20 may be substantially at a height corresponding to that of a bottom end of the tube 31 to be easily stored.

When the tripod base is going to be used, the flat base 10 slides toward the bottom end of the tube 31, then each supporting rod 20 is pivoted to be fastened in a corresponding slot 12. The bump 142 of the fastening element 14 is compressed by the corresponding supporting rod 20 and is stuck into the tube mounting hole 11 to fasten the tube 31 in the tube mounting hole 11 without any screwing process.

As demonstrated by the above descriptions, the tripod base with enhanced support force in accordance with the invention has at least the following advantages.

1. The loading over the flat base 10 is dispersed by the triangle configuration to enhance the support capability of the tripod base.

2. The center of gravity of the flat base 10 is lowered to prevent the tripod base from falling down.

3. The tripod base can be folded to save the storage space, helpful for carrying and storing.

4. The fastening element is used to securely fasten the tube of the stand in the tripod base. When the stand is going to be stored, the flat base can slide along the tube of the stand. Therefore, the entire stand will not become longer in length and is convenient for storage.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tripod base with enhanced support force comprises:
a flat base comprising:
a side;
a bottom surface;
a tube mounting hole formed through the bottom surface; and
three slots formed in the bottom surface, each slot having an inner closed end and an outer open end that is formed through the side;
wherein the three slots are arranged as a triangle around the tube mounting hole as a center; and
three supporting rods pivotally mounted in the three slots, each of the supporting rods comprising:
a first end pivotally mounted in the inner closed end of one of the slots;
an inner segment near the first end held in one of the slots; and
a second end exposed outside of the flat base.

2. The tripod base as claimed in claim 1, wherein the flat base further comprises:
at least one through hole communicating with the tube mounting hole and one of the slots; and
at least one fastening element mounted in the at least one through hole and protruding toward the slot; and
wherein the at least one fastening element is able to be pushed by one of the supporting rods and moves toward the tube mounting hole.

3. The tripod base as claimed in claim 2, wherein the at least one fastening element comprises
a prop-press piece facing toward the tube mounting hole; and
a bump formed on the prop-press piece and protruding toward the slot.

4. The tripod base as claimed in claim 3, wherein the flat base comprises:
the three through holes, each of the three through holes communicating with the tube mounting hole and one of the slots; and
the three fastening elements, each of the fastening elements being mounted in one of the three through holes.

5. The tripod base as claimed in claim 1, wherein the flat base further comprises:
three pin-jointed bases formed in the three slots near the inner closed ends respectively, each of the pin-jointed bases comprising
two plates in parallel, each of the two plates having an axial hole;
wherein the flat base further has multiple holes formed through the side and each of the hole corresponds to the axial holes of a pin-jointed base.
